(19) United States
(12) Patent Application Publication
(10) Pub. No.: US 2012/0105780 A1
(43) Pub. Date: May 3, 2012

(54) LIQUID CRYSTAL DISPLAY INTEGRATED WITH SOLAR CELL MODULE

(76) Inventors: Ren-Hong Jhan, Hsin-Chu (TW); Chun-Hao Tu, Hsin-Chu (TW); Kuo-Sen Kung, Hsin-Chu (TW); Wei-Jhih Lian, Hsin-Chu (TW); Yu-Jung Liu, Hsin-Chu (TW); Jiun-Jye Chang, Hsin-Chu (TW); Po-Lun Chen, Hsin-Chu (TW); Shui-Chih Lien, Hsin-Chu (TW)

(21) Appl. No.: 13/179,569

(22) Filed: Jul. 11, 2011

(30) Foreign Application Priority Data
Oct. 29, 2010 (TW) 099137291

(51) Int. Cl. G02F 1/135

(52) U.S. Cl. 349/116

(57) ABSTRACT

The present invention provides a liquid crystal display integrated with a solar cell module, which includes a first transparent substrate, a second transparent substrate, a cholesteric liquid crystal layer, a third transparent substrate, and a photoelectric conversion layer. The second transparent substrate is disposed on a side of the first transparent substrate, and the cholesteric liquid crystal layer is disposed between the first transparent substrate and the second transparent substrate. The third transparent substrate is disposed on the other side of the first transparent substrate opposite to the second transparent substrate, and the photoelectric conversion layer is adhered between the first transparent substrate and the third transparent substrate. The first transparent substrate, the photoelectric conversion layer and the third transparent substrate constitute the solar cell module.

### BACKGROUND OF THE INVENTION

1. Field of the Invention

The present invention relates to a liquid crystal display, and more particularly, to a liquid crystal display integrated with a solar cell module.

2. Description of the Prior Art

Due to the advancement of electrical technology, many electric products have more variable functions and smaller sizes. The most obvious example is that desktop computers are gradually replaced by portable computers. The portable computer has the advantage of portability, but the operation of the portable computer still requires power provided by a cell or an extra AC transformer connected to an outside power. For this reason, when the portable computer is carried to a place without a power plug, especially the outdoors, the operating time of the portable computer is limited by the power of the cell.

In order to extend the operating time of the portable computer in the outdoors, a solar cell has been developed to provide operating power of the portable computer and to recharge the cell, so that the cell of the portable computer can be recharged to continue operating the portable computer through the irradiation of the sunlight when the cell is used up. However, to carry a solar cell charger is a large burden for user. Furthermore, for reducing the extra burden, the solar cell charger assembled into the portable computer has been developed to avoid the extra burden.

To reduce the weight of the portable computer integrated with the solar cell charger and to decrease manufacturing cost are important objectives in this field.

### SUMMARY OF THE INVENTION

It is therefore a primary objective of the present invention to provide a liquid crystal display integrated with a solar cell module to solve the above-mentioned problem.

According to a preferred embodiment of the present invention, a liquid crystal display integrated with a solar cell module is disclosed. The liquid crystal display includes a display device, a third transparent substrate, and a photoelectric conversion layer. The display device includes a first transparent substrate, a second transparent substrate, a cholesteric liquid crystal layer, an electrode layer and a common electrode layer. The first transparent substrate has a first side and a second side opposite to the first side, and the second transparent substrate is disposed on the first side of the first transparent substrate. The cholesteric liquid crystal layer is disposed between the first transparent substrate and the second transparent substrate. The electrode layer is disposed between the first transparent substrate and the cholesteric liquid crystal layer, and the common electrode layer, disposed between the second transparent substrate and the cholesteric liquid crystal layer. The third transparent substrate is disposed on the second side of the first transparent substrate, and the photoelectric conversion layer is adhered between the first transparent substrate and the third transparent substrate. The first transparent substrate, the third transparent substrate and the photoelectric conversion layer constitute the solar cell module.

The present invention integrates the cholesteric liquid crystal display and the solar cell module, and the solar cell module shares the first transparent substrate of the display device, so that the material cost of the substrate can be saved, and the whole weight of the liquid crystal display is reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a liquid crystal display integrated with a solar cell module according to a first preferred embodiment of the present invention.

FIG. 2 illustrates another example of the liquid crystal display integrated with the solar cell module according to the first preferred embodiment of the present invention.

FIG. 3 is a schematic diagram illustrating the liquid crystal display being in a brightness state according to the present invention.

FIG. 4 is a schematic diagram illustrating the liquid crystal display being in the dark state according to the present invention.

FIG. 5 is a schematic diagram illustrating a cross-sectional view of a liquid crystal display integrated with a solar cell module according to a second preferred embodiment of the present invention.

FIG. 6 is a schematic diagram illustrating a top view of the liquid crystal display integrated with the solar cell module according to the second preferred embodiment of the present invention.

FIG. 7 is a schematic diagram illustrating a cross-sectional view of a liquid crystal display integrated with a solar cell module according to a third preferred embodiment of the present invention.

### DETAILED DESCRIPTION

To provide a better understanding of the present invention, preferred embodiments will be detailed as follows. The preferred embodiments of the present invention are illustrated in the accompanying drawings with numbered elements to elaborate the contents and effects to be achieved.

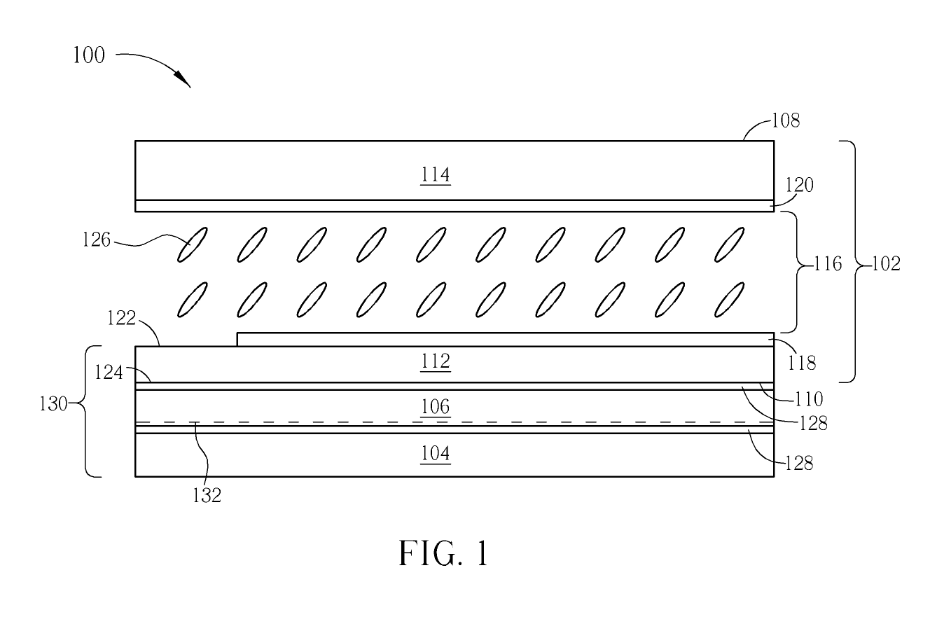

Refer to FIG. 1, which is a schematic diagram illustrating a liquid crystal display integrated with a solar cell module according to a first preferred embodiment of the present invention. FIG. 1 is a schema in order to easily understand the present invention, and detailed size can be adjusted according to the designed requirements. As shown in FIG. 1, the liquid crystal display 100 integrated with the solar cell module includes a display device 102, a third transparent substrate 104, and a photoelectric conversion layer 106. The display device 102 has a displaying surface 108 and a back surface 110, and the photoelectric conversion layer 106 is adhered to the back surface 110 of the display device 102. Also, the third transparent substrate 104 is further adhered to the photoelectric conversion layer 106, so that the photoelectric conversion layer 106 can be protected from being damage from the outside. The display device 102 includes a first transparent substrate 112, a second transparent substrate 114, a cholesteric liquid crystal (CLC) layer 116, an electrode layer 118, and a common electrode layer 120. The first transparent substrate 112 has a first side 122 and a second side 124 opposite to the first side 122. The first side 122 of the first transparent substrate 112 faces the displaying surface 108 of the display device 102, and the second side 124 of the first transparent substrate 112 faces the back surface 110 of the display device 102. In addition, the second transparent substrate 114 is disposed on the first side 122 of the first transparent substrate 112, and the CLC layer 116 is disposed between the first transparent substrate 112 and the second transparent substrate 114. The electrode layer 118 is disposed between the first transparent substrate 112 and the CLC layer 116, and the common electrode layer 120 is disposed between the second transparent substrate 114 and the CLC layer 116. A plurality of liquid crystal molecules in the CLC layer 116 can be driven to rotate by provide a voltage difference between the electrode layer 118 and the common electrode layer 120, and the displaying surface 108 of the display device 102 can display a required image. The display device 102 of the present invention is a cholesteric liquid crystal display. In addition, in order to display color images in the cholesteric liquid crystal display, the CLC layer in a single pixel region may be divided into at least three parts, respectively corresponding to different sub-pixel regions, such as blue sub-pixel region, red sub-pixel region, and green sub-pixel region. Furthermore, the CLC layer in different sub-pixel regions may be respectively added with different chiral dopants having different chiral pitches, or added with the same chiral dopants that are exposed for different times, so that the CLC layer in each sub-pixel region can display different colors, such as blue, red, green, etc.

In this embodiment, the third transparent substrate 104 is disposed on the second side 124 of the first transparent substrate 112, and the photoelectric conversion layer 106 is adhered between the first transparent substrate 112 and the third transparent substrate 104. In addition, the liquid crystal display 100 further includes two adhesive layers 128, respectively used to combine the first transparent substrate 112 and the photoelectric conversion layer 106 and to combine the third transparent substrate 104 and the photoelectric conversion layer 106, and the first transparent substrate 112, the photoelectric conversion layer 106 and the third transparent substrate 104 can constitute a solar cell module 130. Accordingly, the solar cell module 130 and the display device 102 can share the first transparent substrate 112 in the present invention. For this reason, the material cost of the present invention can be reduced as compared with the display device and the solar cell module according to the prior art that respectively require two substrates to manufacture, and the whole weight of the liquid crystal display 100 of the present invention can be reduced. The first transparent substrate 112, the second transparent substrate 114 and the third transparent substrate 104 can respectively be a transparent substrate, such as glass or plastic, but are not limited herein.

Furthermore, the photoelectric conversion layer 106 is composed of a PN diode, and is used to convert sunlight into electric power that is provided to the display device 102. The photoelectric conversion layer 106 has a light-absorbing surface 132 that is used to convert the light into electric current, and the light-absorbing surface 132 is adjacent to the first transparent substrate 112. When the light can penetrate the CLC layer 116, the light can further penetrate the first transparent substrate 112 and then go into the photoelectric conversion layer 106. The light emitted into the liquid crystal display 100 can be absorbed by the light-absorbing surface 132 of the photoelectric conversion layer 106, so that the liquid crystal display 100 displays a black image and is in a dark state.

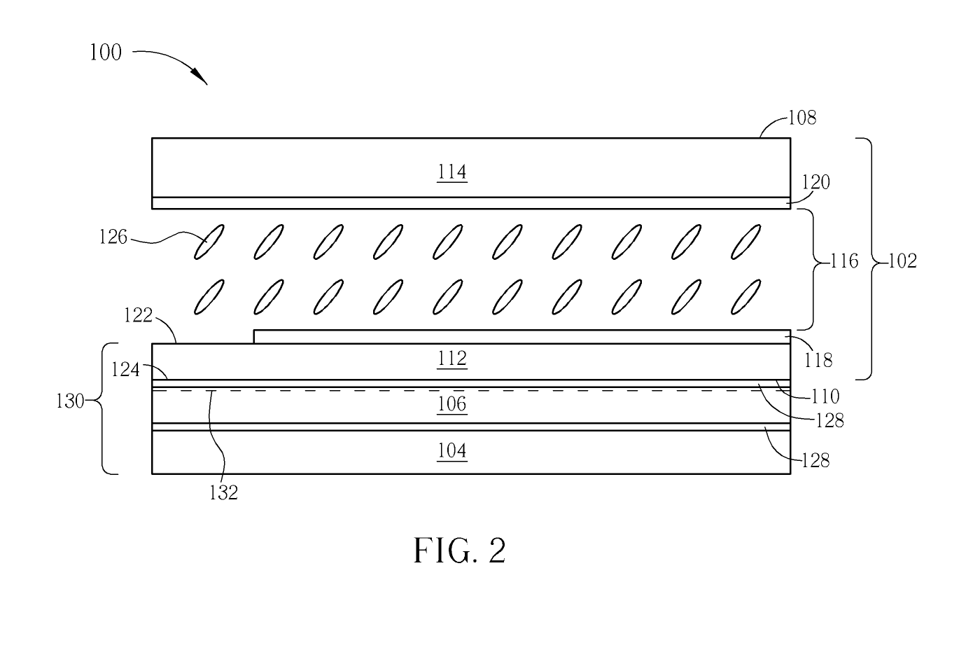

The light-absorbing surface of the photoelectric conversion layer in the present invention does not limited to be adjacent to the first transparent substrate. Refer to FIG. 2, which illustrates another example of the liquid crystal display integrated with the solar cell module according to the first preferred embodiment of the present invention. As shown in FIG. 2, as compared with the liquid crystal display of the first embodiment, the light-absorbing surface 132 of the photoelectric conversion layer 106 in this example is disposed adjacent to the third transparent substrate 104, so that the most part of the light from the outside of the third transparent substrate 104 can be absorbed by the light-absorbing surface without penetrating the substrate constituting the PN diode. In other embodiments of the present invention, the photoelectric conversion layer 106 also can be composed of two PN diodes, and the two PN diodes are respectively disposed adjacent to the first transparent substrate 112 and adjacent to the third transparent substrate 104. Thus, the light from the first transparent substrate 112 to the photoelectric conversion layer 106 and the light from the third transparent substrate 104 to the photoelectric conversion layer 106 can be absorbed by the photoelectric conversion layer 106. For this reason, more light can be effectively absorbed.

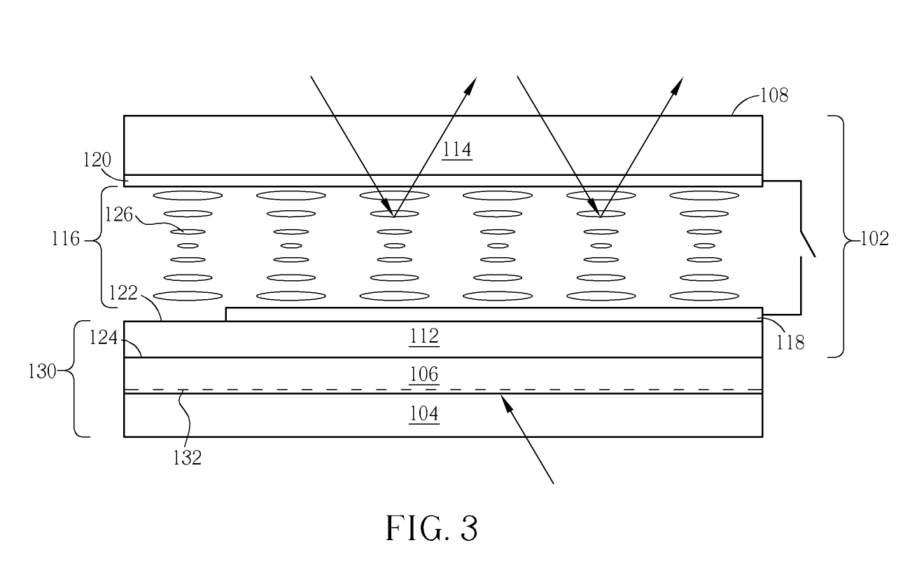

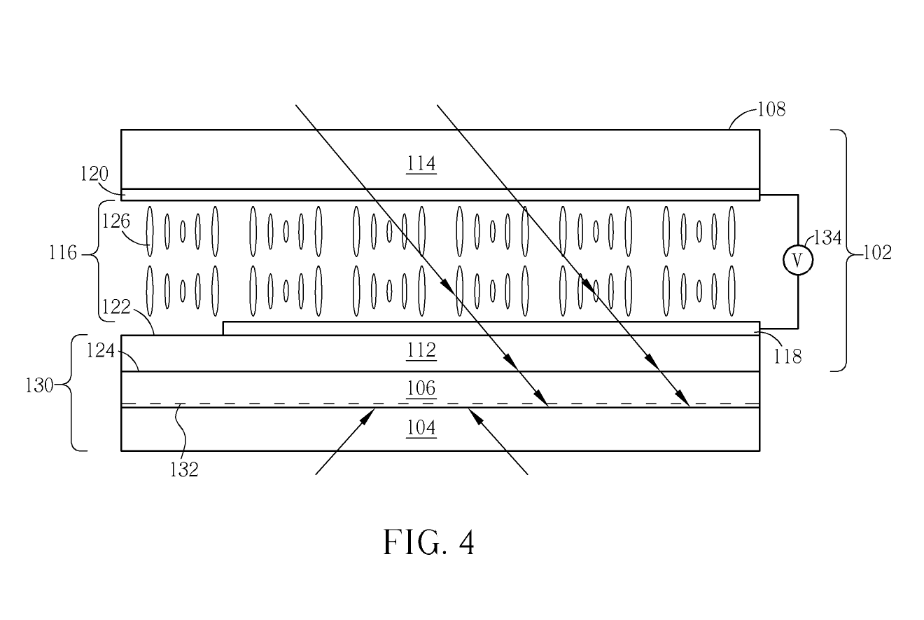

The following description further details the operation method of the liquid crystal display in this embodiment. Refer to FIG. 3 and FIG. 4. FIG. 3 is a schematic diagram illustrating the liquid crystal display being in a brightness state according to the present invention, and FIG. 4 is a schematic diagram illustrating the liquid crystal display being in the dark state according to the present invention. As shown in FIG. 3, when no electric field is provided between the electrode layer 118 and the common electrode layer 120 of the liquid crystal display 100, an optical state of the liquid crystal molecules 126 in the CLC layer 116 is aligned in a planar texture. Meanwhile, the CLC layer 106 reflects the light with a specific wavelength, and the wavelength of the light reflected by the CLC layer 106 can be fixed in the wavelength range of visible light by adjusting the spacing between the liquid crystal molecules 126. Therefore, when the light from the displaying surface 108 of the display device 102 penetrates through the common electrode layer 120, the light is reflected by the CLC layer 116 and goes toward the common electrode layer 120. Then, the light further penetrates through the common electrode 120 and the second transparent substrate 114, and is emitted outward from the displaying surface 108 of the display device 102. Accordingly, the liquid crystal display 100 displays a white image, and is in a brightness state.

As shown in FIG. 4, when a power source 134 is electrically connected between the electrode layer 118 and the common electrode layer 120 of the liquid crystal display 100 and provides a voltage difference, the optical state of the liquid crystal molecules 126 in the CLC layer 116 is aligned in a fingerprint texture, and meanwhile, the CLC layer 116 is transparent. When the light go into the displaying surface 108 of the display device 102, the light would penetrate through the common electrode layer 120, and then penetrate through the CLC layer 126 directly. Thereafter, the light penetrates through the electrode layer 118 and the first transparent substrate 112 in sequence, and then is absorbed by the photoelectric conversion layer 106. Thus, the displaying surface 108 of the display device 102 do not emit light, so that the liquid crystal display 100 displays the black image and is in the dark state. On the other hands, no matter what state the liquid crystal display 100 have, the light from the outside of the third transparent substrate 104 is absorbed by the photoelectric conversion layer 106, and does not go into the display device 102.

As the above-mentioned description, the liquid crystal display 100 in this embodiment is a reflective liquid crystal display. When the liquid crystal display 100 is used under sunlight, the sunlight can be effectively used as a light source for displaying, so that a problem of low contrast ratio is prevented from being generated under strong light. Furthermore, it should be noted that the liquid crystal display 100 in this embodiment not only can convert the light into electric power but also save a black absorbing layer used for absorbing light in the cholesteric liquid crystal display of the prior art through the photoelectric conversion layer 106 absorbing the incident light, and the manufacturing cost also can be reduced.

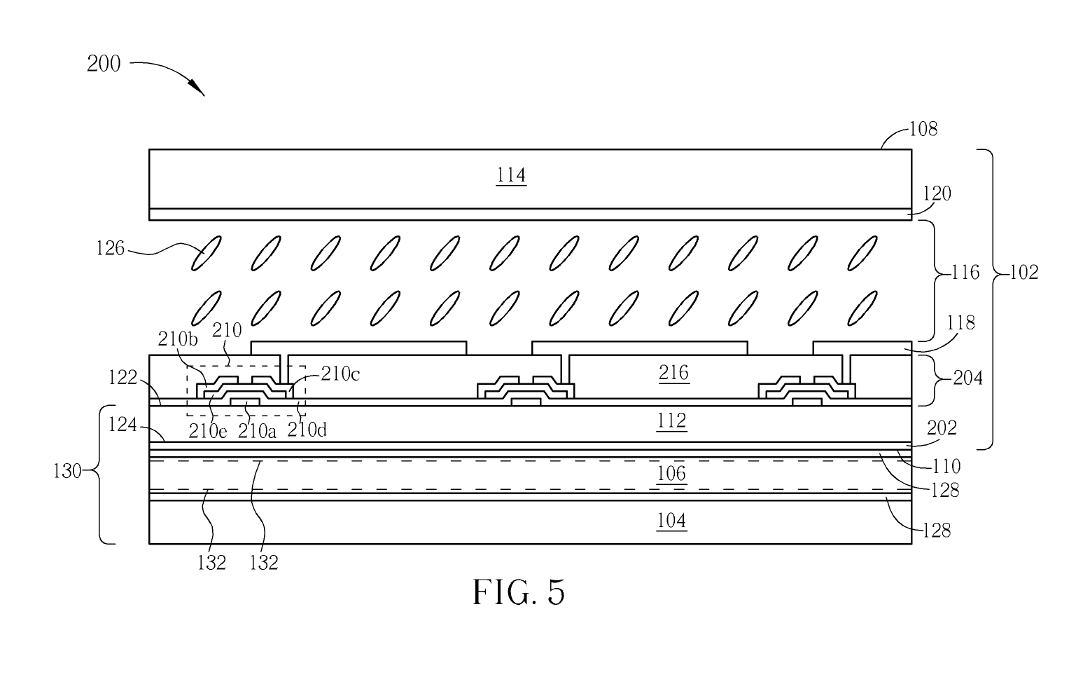

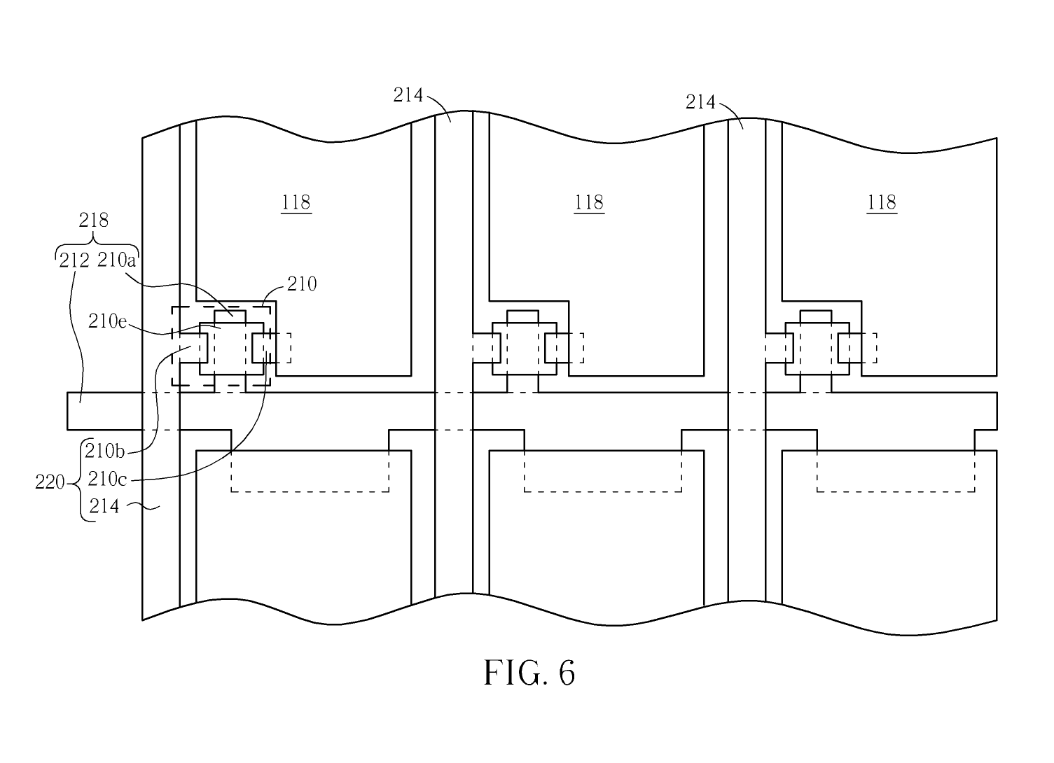

In addition, the liquid crystal display of the present invention can further include an anti-reflective layer so as to help the light going into the photoelectric conversion layer, and the following description further details the structure of the display device. Refer to FIG. 5 and FIG. 6. FIG. 5 is a schematic diagram illustrating a cross-sectional view of a liquid crystal display integrated with a solar cell module according to a second preferred embodiment of the present invention, and FIG. 6 is a schematic diagram illustrating a top view of the liquid crystal display integrated with the solar cell module according to the second preferred embodiment of the present invention. For clarity, the same numerals denote the same components in the following embodiments, and the same parts are not detailed redundantly. As shown in FIG. 5 and FIG. 6, as compared with the first preferred embodiment, the liquid crystal display 200 in this embodiment further includes an anti-reflective layer 202, covering the second side 124 of the first transparent substrate 112, and the anti-reflective layer 202 is disposed between the photoelectric conversion layer 106 and the first transparent substrate 112. A surface of the anti-reflective layer 202 facing the first transparent substrate 112 has a function of preventing light from being reflected, and another surface of the anti-reflective layer 202 facing the photoelectric conversion layer 106 has a function of reflecting light. The anti-reflective layer 202 can include an anti-reflective material, such as silicon nitride, etc., and is not limited to this. Furthermore, the display device 202 in this embodiment further includes an array circuit layer 204. The photoelectric conversion layer 106 in this embodiment is composed of two PN diodes, and has two light-absorbing surfaces 132, respectively disposed adjacent to the first transparent substrate 112 and adjacent to the third transparent substrate 104. The array circuit layer 204 is disposed on the first side 122 of the first transparent substrate 112, and is electrically connected to the electrode layer 118. The array circuit layer 204 includes a plurality of thin-film transistors 210, a plurality of scan lines 212, a plurality of data lines 214, and a passivation layer 216, and each thin-film transistor 210 has agate electrode 210a, a source electrode 210b, a drain electrode 210c, an insulating layer 210d, and a semiconductor layer 210e. The scan lines 212 and the gate electrodes 210a are composed of a first conductive layer 218, and the data line 214, the source electrode 210b and the drain electrode 210c are composed of a second conductive layer 220. The first conductive layer 218, the insulating layer 210d, the semiconductor layer 210e, the second conductive layer 220 and the passivation layer 216 are respectively disposed on the first side 122 of the first transparent substrate 112 in sequence, and the electrode layer 118 is disposed on the passivation layer 216. Furthermore, the passivation layer 216 covers the thin-film transistors 210, and exposes apart of each drain electrode 210c of each thin-film transistor 210, so that the electrode layer 118 can be electrically connected to the drain electrodes 210c of the thin-film transistors 210. In this embodiment, materials of forming the first conductive layer 218 and the second conductive layer 220 can include metal materials, such as molybdenum (Mo), tantalum (Ta), chromium (Cr) and aluminum (Al), but are not limited herein.

In other embodiments, the scan lines, the data lines, the gate electrodes, the source electrodes and the drain electrodes also can respectively include a transparent conductive material, such as indium-zinc oxide (IZO) or indium-tin oxide (ITO), etc., but the present invention is not limited to this. Accordingly, when the liquid crystal display is in dark state, the scan lines, the data lines, the gate electrodes, the source electrodes and the drain electrodes does not reflect the light from the outside, so that the liquid crystal display can display a good black image, and has high contrast ratio.

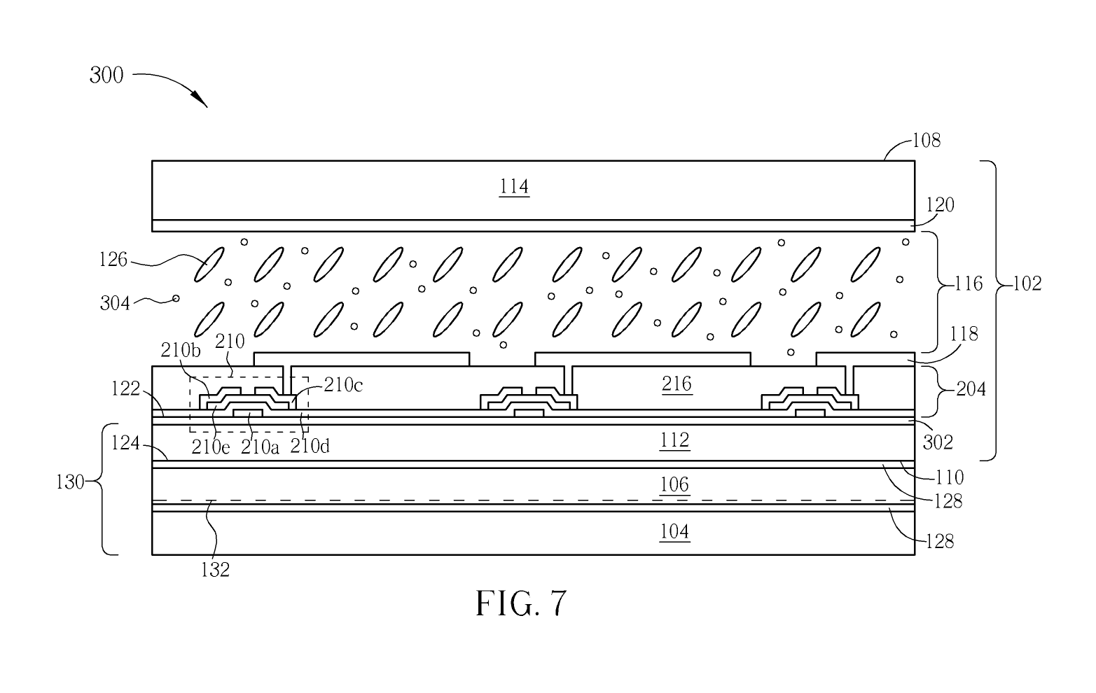

Besides, the anti-reflective layer of the present invention is not limited to be disposed between the first transparent substrate and the photoelectric conversion layer, and also can be disposed between the first transparent substrate and the CLC layer. Refer to FIG. 7, which is a schematic diagram illustrating a cross-sectional view of a liquid crystal display integrated with a solar cell module according to a third preferred embodiment of the present invention. As shown in FIG. 7, as compared with the second preferred embodiment, the anti-reflective layer 302 of the liquid crystal display 300 in this embodiment covers the first side 122 of the first transparent substrate 112, and the anti-reflective layer 302 is disposed between the array circuit layer 204 and the CLC layer 116. Accordingly, light penetrates through the anti-reflective layer 302 before penetrating the first transparent substrate 112, and the most part of light can be confined in the solar cell module 130. The liquid crystal display 300 can display good black images, and the contrast ratio can be raised. Besides the liquid crystal molecules 126, the CLC layer 116 in this embodiment further includes a chiral dopant, doped into the liquid crystal molecules 126, and the CLC layer 116 can display different colors.

In other embodiments of the present invention, the anti-reflective layer can be disposed between the CLC layer and the photoelectric conversion layer so as to guide the light penetrating through the CLC layer to the photoelectric conversion layer.

In summary, the present invention integrates the cholesteric liquid crystal display and the solar cell module, so that the solar cell module shares the array substrate of the cholesteric liquid crystal display. As compared with the liquid crystal display and the solar cell module of the prior art being manufactured respectively and then being combined with each other, the present invention can save one substrate so as to reduce the whole weight of the liquid crystal display. Furthermore, the present invention utilizes the reflective type cholesteric liquid crystal display as the display device, so that the liquid crystal display can effectively use the outside sunlight as light source for displaying. Therefore, the problem of reducing the contrast ratio under strong light can be avoided.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal display integrated with a solar cell module, comprising:
a display device, comprising:
a first transparent substrate, having a first side and a second side opposite to the first side;
a second transparent substrate, disposed on the first side of the first transparent substrate;
a cholesteric liquid crystal layer, disposed between the first transparent substrate and the second transparent substrate;
an electrode layer, disposed between the first transparent substrate and the cholesteric liquid crystal layer; and
a common electrode layer, disposed between the second transparent substrate and the cholesteric liquid crystal layer;
a third transparent substrate, disposed on the second side of the first transparent substrate; and
a photoelectric conversion layer, adhered between the first transparent substrate and the third transparent substrate, and the first transparent substrate, the third transparent substrate and the photoelectric conversion layer constituting the solar cell module.

2. The liquid crystal display according to claim 1, wherein the photoelectric conversion layer has a light-absorbing surface, and the light-absorbing surface is adjacent to the third transparent substrate.

3. The liquid crystal display according to claim 1, wherein the photoelectric conversion layer has a light-absorbing surface, and the light-absorbing surface is adjacent to the first transparent substrate.

4. The liquid crystal display according to claim 1, wherein the photoelectric conversion has two light-absorbing surfaces, and the light-absorbing surfaces are respectively adjacent to the first transparent substrate and adjacent to the third transparent substrate.

5. The liquid crystal display according to claim 1, wherein the display device further comprising an anti-reflective layer, disposed between the cholesteric liquid crystal layer and the photoelectric conversion layer.

6. The liquid crystal display according to claim 5, wherein the anti-reflective layer is disposed between the photoelectric conversion layer and the first transparent substrate.

7. The liquid crystal display according to claim 5, wherein the anti-reflective layer covers the first side of the first transparent substrate and is disposed between the first transparent substrate and the cholesteric liquid crystal layer.

8. The liquid crystal display according to claim 5, wherein the anti-reflective layer comprises silicon nitride.

9. The liquid crystal display according to claim 1, wherein the display device further comprises a plurality of thin-film transistors, a plurality of data lines, and a plurality of scan lines, disposed between the cholesteric liquid crystal layer and the first transparent substrate, and each thin-film transistor has a gate electrode, a drain electrode and a source electrode.

10. The liquid crystal display according to claim 9, wherein the scan lines, the data lines, the gate electrodes, the source electrodes and the drain electrodes respectively comprise a transparent conductive material.

11. The liquid crystal display according to claim 1, further comprising two adhesive layers, respectively combining the first transparent substrate and the photoelectric conversion layer and combining the third transparent substrate and the photoelectric conversion layer.

12. The liquid crystal display according to claim 1, wherein the cholesteric liquid crystal layer comprises a plurality of liquid crystal molecules, and a chiral dopant, and the chiral dopant is doped into the liquid crystal molecules.
